(19) United States
(12) Patent Application Publication
(10) Pub. No.: US 2024/0395431 A1
(43) Pub. Date: Nov. 28, 2024

(54) LINEAR-ROTARY CAPSULE ACTUATOR FOR NUCLEAR SOURCE HOLDER

(71) Applicant: Vega Americas, Inc., Mason, OH (US)

(72) Inventor: Randall L. Flower, Maineville, OH (US)

(21) Appl. No.: 18/690,955

(22) PCT Filed: Sep. 9, 2022
(86) PCT No.: PCT/US2022/042989

§ 371 Date: Mar. 11, 2024

Related U.S. Application Data
(60) Provisional application No. 63/242,287, filed on Sep. 9, 2021.

(51) Int. Cl. G21F 5/04; G21F 5/06; G21G 4/06

(52) U.S. Cl. CPC G21F 5/04; G21F 5/06; G21G 4/06

(57) ABSTRACT

A radiation source holder holds a source carrier in a passageway such that a capsule in the source carrier it may be linearly positioned in an ON or OFF position to control emission of gamma radiation from the source holder. Linear and rotary cams having linear and rotary cam surfaces interact with cam guides on the source carrier so that linear movement of the source carrier and capsule between said ON and OFF positions can be effected by rotation of the rotary cam.

### RELATED APPLICATIONS

This application is a non-provisional of U.S. Provisional Application Ser. No. 63/242,287 filed Sep. 9, 2021, which is incorporated herein in its entirety.

### FIELD OF THE INVENTION

The present invention relates to radiant energy and, more particularly, to a gamma radiation source holder that includes containment structure using shielding material to collimate gamma radiation from a source toward a target, e.g. for level detection.

### BACKGROUND OF THE INVENTION

In harsh industrial environments, it can be desirable to use nuclear level sensing gauges to detect the level of product in a holding tank or bin. Nuclear level sensors are typically attached to the holding tank or bin, and electrically connected to remote gauges at a control room or other central location, where technicians or control systems may monitor the status of the bins to provide the appropriate process control.

In a nuclear level sensing gauge, a source of gamma radiation is positioned in a holder on one side of the bin to be level sensed. A radiation detector is placed on the opposite side of the bin. The radiation exiting the source is in the shape of a beam directed towards the interior of the bin. The beam may be collimated to a pencil shape, or in a fan shape, depending upon the detector being used. In any case, the product in the bin absorbs radiation that impinges upon it, so that based upon the amount of product in the bin, a proportionate amount of the radiant energy from the source passes through the bin and irradiates the radiation detector on the opposite side of the bin from the radiation source. As a result, the amount of radiation stimulating the radiation detector is inversely proportional to the amount of product in the bin. Typically, the radiation reaching the detector creates scintillating light flashes in the detector, with the number of light flashes is proportional to the intensity of the incident radiation. A high sensitivity light sensor converts the light flashes into electrical pulses, which are amplified and evaluated by electronics to produce a measurement of the amount of product in the bin.

Due to the hazardous nature of the radiant energy source, the source holder in a nuclear level sensing gauge must meet strict safety standards. These safety standards dictate that the source holder prevent the external release of radiation from the radiant source capsule. Typically, the source holder uses lead surrounding the source on all sides, except for the aperture directed to the product and bin and detector.

Many sources include a selectable aperture, or shutter, allowing the radioactive source capsule to be moved between a first position in which radiation is emitted through the aperture, and a second position in which the shielding in the source holder blocks radiation from the passing through the aperture. Typically, the aperture is manually activated from outside of the source holder. U.S. Pat. No. 2,984,748 illustrates a representative arrangement of lead and a source capsule in a prior art radiation source holder. In this example, the source holder includes a rotary shutter for on/off selection of the source. Specifically, the radiation source capsule is mounted within a rotor that is itself surrounded by lead shielding. There is an aperture in the lead shielding, and the rotor may be spun by an operator to an “on” position, where the source and aperture align so that radiation is emitted and projected outside of the holder and may be spun to an “off” position in which the source does not align with the aperture and radiation is prevented from emitting from the source through the aperture.

Various other source holder structures are known in the art which provide a rotary shutter feature. However, these rotary shutters have the disadvantage that larger activity sources tend to require greater shielding, and a greater range of rotary movement to move the source to a suitably “off” position. This tends to make the entire size of the source holder larger than would be desired. Thus, there is a need for a source holder with a shutter that maintains a relatively compact size as compared to conventional rotary shutter source holders.

### SUMMARY OF THE INVENTION

The radiation source holder described herein improves upon prior source holders by providing a source carrier including cam followers that engage with rotary and linear cams included in the holder, such that rotation of the rotary cam causes linear positioning of the source carrier inside of the shielding between said ON and OFF positions. The rotary-to-linear motion conversion allows for a more compact structure than could be achieved using a rotary shutter as is known in the prior art.

In the particular disclosed embodiment, the source holder comprises a housing substantially filled with radiation shielding material and defining an elongated source passageway with an aperture extending therefrom. The source carrier is positioned in the passageway. The carrier includes a rotary cam guide which engages a spiral cam surface on the rotary cam, and a linear cam guide which engages a linear cam surface on the linear cam, so that rotation of the rotary cam causes cooperative engagement and linear motion of the source holder.

In this embodiment, the carrier has a tubular body, and a guide shaft extending from the tubular surface, with the linear and rotary cam guides positioned for rotation on the guide shaft. The guide shaft extends through the source carrier and from first and second sides of the source carrier, and linear and rotary cam guides are positioned on the guide shaft on both sides of the carrier to cooperate with the linear and spiral cam surfaces of the linear and rotary cams.

The objects and advantages of the present invention shall be made further apparent from the accompanying drawings and the description thereof.

### BRIEF DESCRIPTION OF THE DRAWINGS

The above advantages and features of the invention and embodiments thereof will be further apparent from the following drawings and detailed description, in which:

FIG. 1 is a perspective view of a radiation source holder in accordance with principles of the present invention, which incorporates a rotary-to-linear motion shutter;

FIG. 2 is an exploded perspective view showing the key components of the source holder of FIG. 1;

FIG. 3 is an exploded perspective view of the source capsule carrier and rotary and linear cams that interact with it in the source holder of FIG. 1;

FIG. 4A is an exploded perspective view of the source capsule enclosure tube, outer guide tube, and rotary and linear cams of the source holder of FIG. 1;

FIG. 4B is a cross sectional perspective view of the components seen in FIG. 4A;

FIG. 5A is a cross sectional perspective view of the assembled source of FIG. 1, in which the source carrier and capsule are withdrawn from the aperture, and illustrating the manner in which the carrier and capsule may be moved into registration with the aperture by relative rotation of the rotary and linear cams;

FIG. 5B is a partial cross sectional perspective view of the assembled source of FIG. 1, in which the source capsule is in registration with the aperture, and illustrating the manner in which the capsule can carrier may be moved out of registration with the aperture by relative rotation of the rotary and linear cams;

FIG. 6A is a cross sectional side view of the assembled source holder of FIG. 1 illustrating the source capsule in the position shown in FIG. 5A; FIG. 6B is a cross sectional side view of the assembled source holder of FIG. 1 illustrating the source capsule in an intermediate position; and FIG. 6C is a cross sectional side view of the assembled source holder of FIG. 1 illustrating the source capsule in the position shown in FIG. 5B; and

FIG. 7 illustrates various embodiments of the shielding used in the source holder of the preceding figures, showing the alternative shapes of aperture that may be used to produce differently collimated or shaped radiation output.

### DETAILED DESCRIPTION OF THE INVENTION

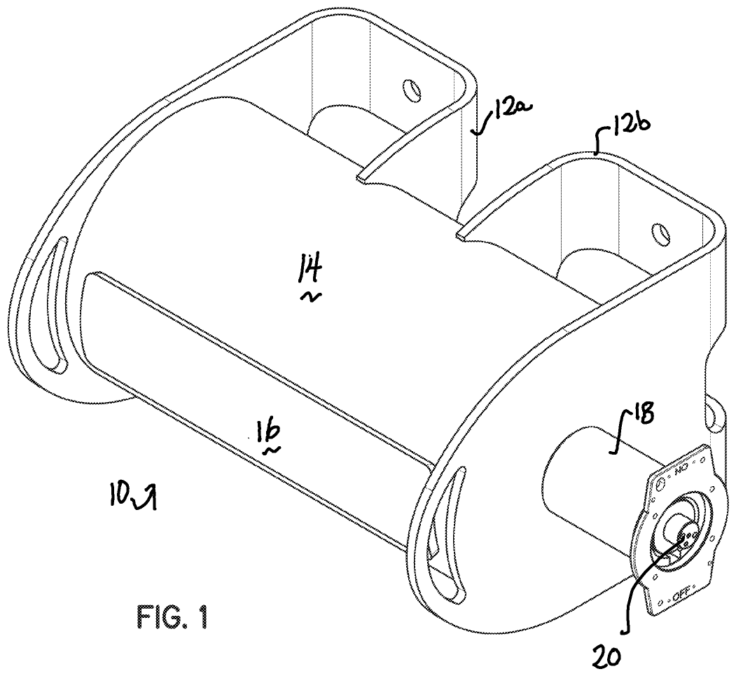

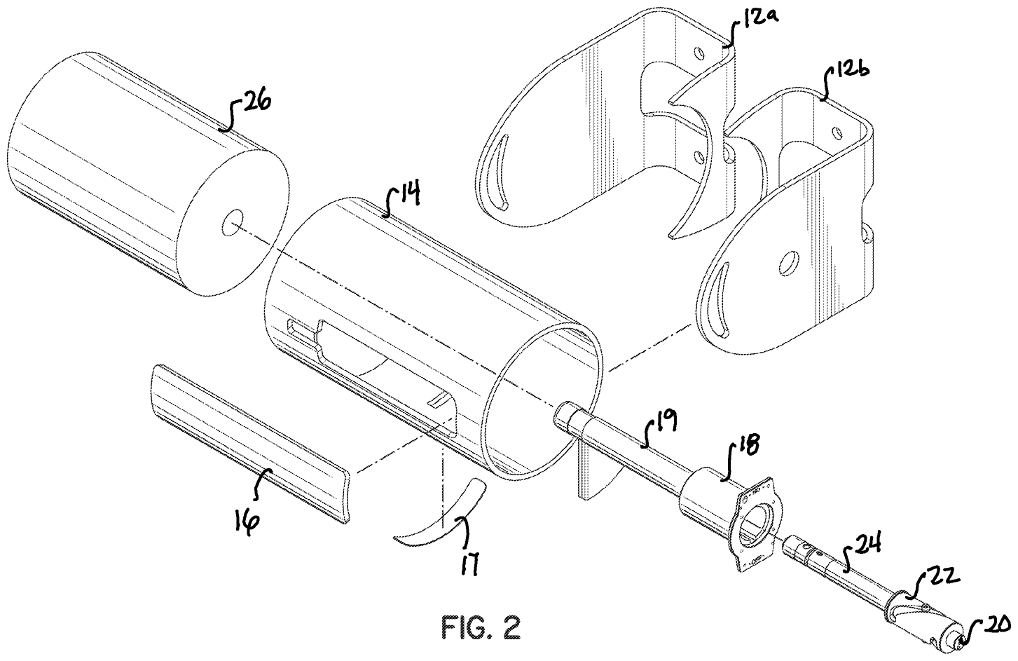

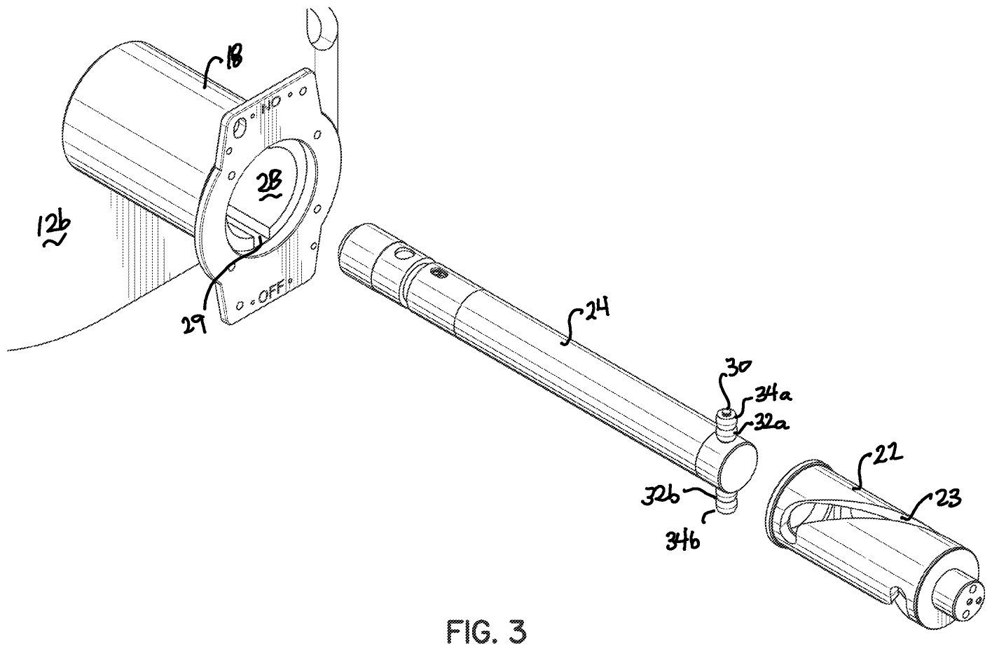

Referring now to the drawing figures, in which like numbers indicate like elements throughout the views, an exemplary embodiment of a radiation source holder 10 comprises, as seen in FIG. 1, an outer housing 14 that is mounted by mounting/end plates 12a, 12b which are mounted, e.g., to the outside of a bin. The outer housing 14 of the source holder 10 and plates 12a, 12b may be comprised of steel or another similar material. As seen in FIGS. 1 and 2, the housing 14 includes one or more removable covers 16, 17 for maintenance of the various internal parts shown in the figures.

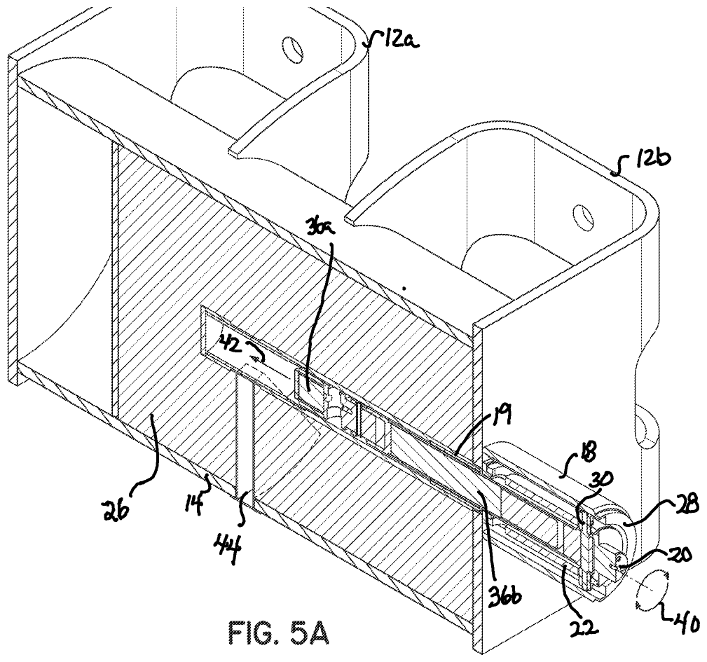

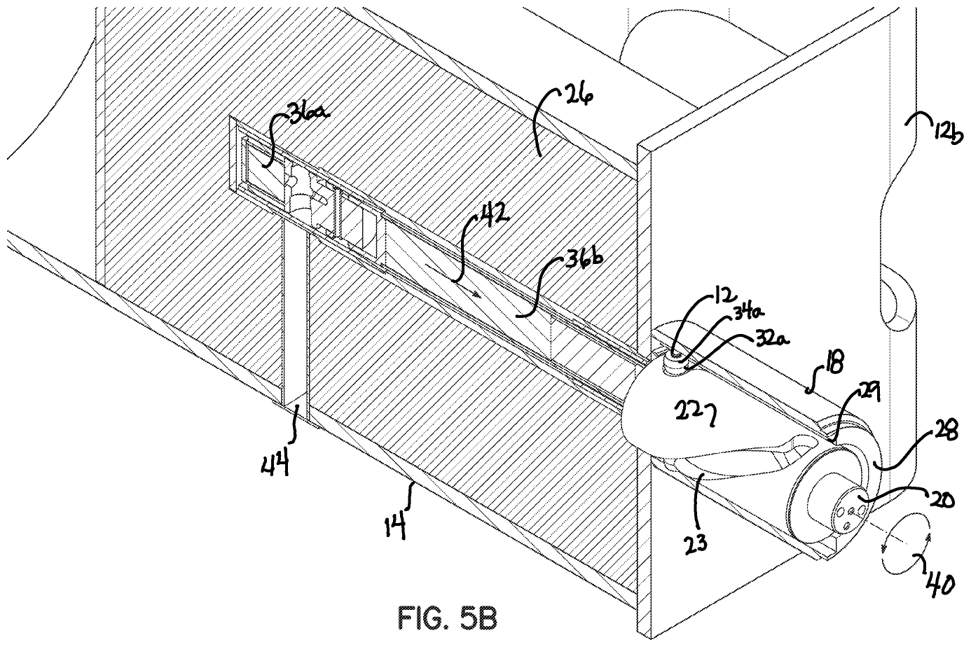

As seen in FIGS. 2 and 5A-6C, the source holder includes structure for containing and positioning a source capsule 38 held in a source carrier 24. The source carrier 24 is positioned in a passageway tube 19 within the source holder 10, permitting linear motion of the carrier to position the capsule 38 into or out of registration with the aperture 44, as shown in FIGS. 5A and 5B. The source carrier includes lead shielding 36a and 36b on either side of the capsule 28 to contain radiation from the capsule from emitting through the source carrier 24.

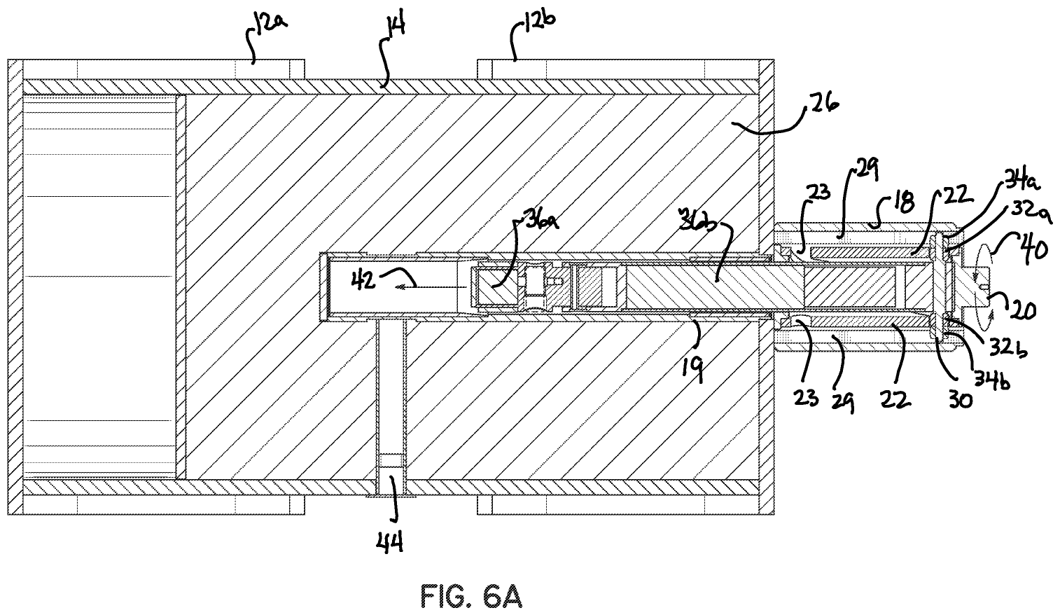

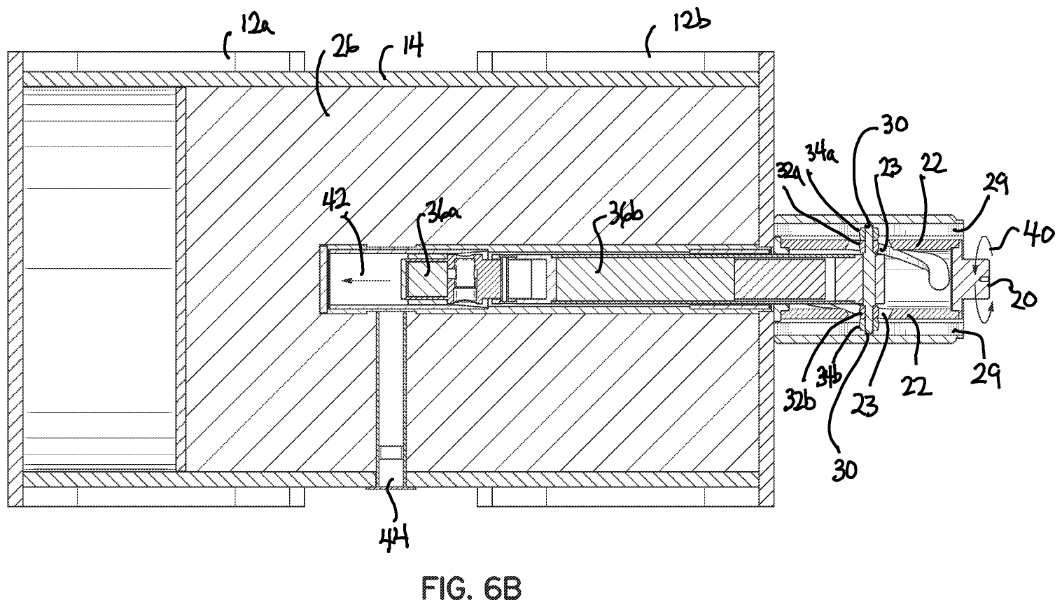

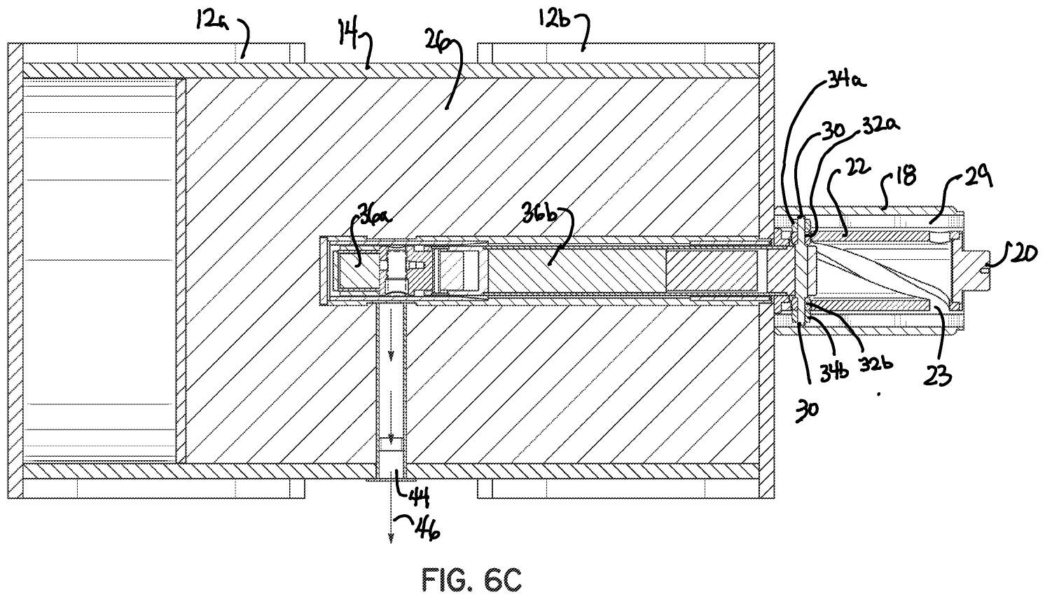

When the source carrier 24 is positioned in an ON position with the capsule in registration with the aperture 44 (see FIGS. 5B and 6C), a beam of radiation with a shape defined by the aperture 44 is emitted from the source, whereas when the source carrier 24 is positioned in an OFF position with the capsule out of registration with the aperture 44 (see FIGS. 5A, 6A), radiation is substantially contained within the source holder 10 by lead shielding 26.

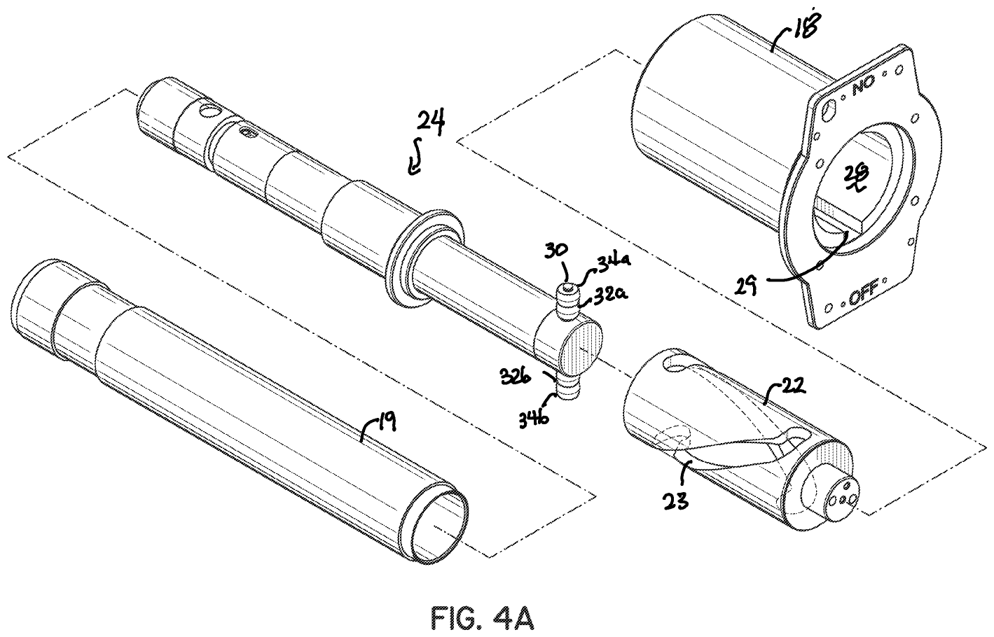

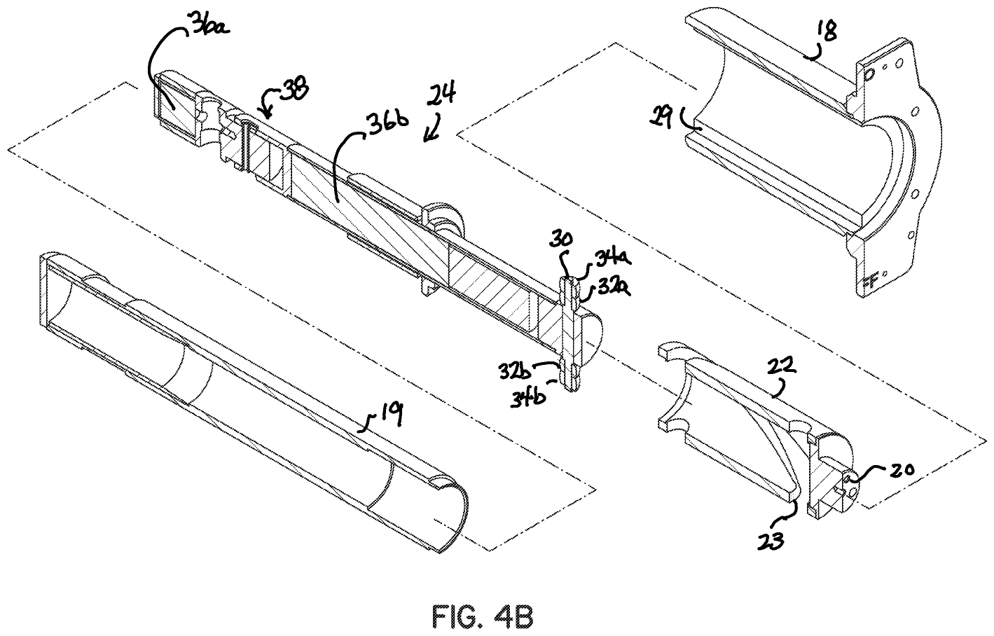

Motion of the source carrier between the ON and OFF positions is induced by cooperative engagement of the source carrier with a rotary cam 22 and linear cam 28 positioned within a source actuator tube 18. Rotary cam 22 includes a spiral cam surface 23 and a linear cam 28 includes a linear cam surface 29. As seen, e.g., in FIG. 4A, source carrier 24 incorporates a cam guide shaft 30 for engaging with the cam surfaces of linear cam 28 and rotary cam 22. Specifically, rotary cam guides 32a, 32b mounted on the cam guide shaft 30 interact with the spiral cam surface 23 of the rotary cam 22, and linear cam guides 34a, 34b mounted on the cam guide shaft 30 interact with the linear cam surface 29 of the linear cam 28.

Rotary force delivered to control knob 20 (as illustrated by arrows 40 shown in FIGS. 5A-5B and 6A-6B) causes cooperative engagement of the cam guides 32a, 32b, 34a and 34b with the spiral and linear cam surfaces 23, 29 to cause the source carrier 24 to be moved linearly within the source passageway 19 (as illustrated by arrows 42 seen in FIGS. 5A-5B and 6A-6B), and between the ON and OFF positions. In the ON position, as seen in FIG. 6C, gamma radiation 46 is emitted from the source holder in a pattern that is defined by the shaping of aperture 44.

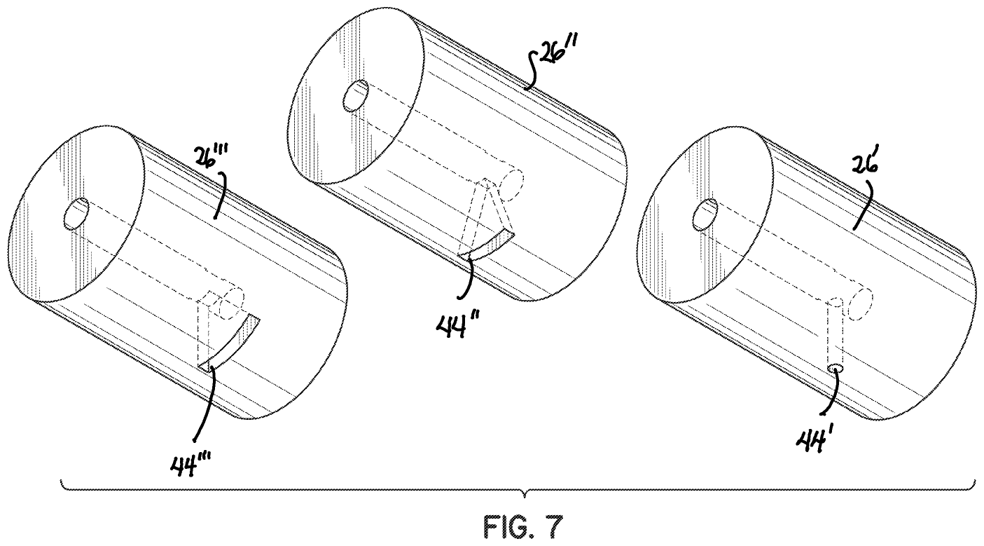

FIG. 7 illustrates various alternative shapes for the aperture 44 defined by the shielding 26, for various applications. The aperture may be a narrow passage 44′ as defined by a first version 26′ of the shield, a narrow angle 44″ as defined by a second version 26″ of the shield, or a wide angle 44′″ as defined by a third version 46″.

As noted, the source may be used in level or density detection; the radiation passing from the aperture continues through product in a bin and impinges upon one or more detectors, typically scintillating crystals, on an opposite side of the bin. The detector(s) produce photons of light when exposed to the radiation. The number of photons produced is related to the amount of radiation impinging on the crystals, and thus measures density and/or level of product.

The present invention has been described in connection with several embodiments and some of those embodiments have been elaborated in substantial detail. However, the scope of the invention is not to be limited by these embodiments which are presented as exemplary and not exclusive. The scope of the invention being claimed is set forth by the following claims.

What is claimed is:

1. A radiation source holder comprising:
a housing;
radiation shielding material substantially filling the housing, and defining an elongated source passageway and an aperture extending therefrom,
a source carrier positioned in the source passageway, the carrier including a rotary cam guide, a linear cam guide and a source capsule emitting gamma radiation, wherein the carrier is positionable in said source passageway in an ON position in which the capsule is in registration with the aperture to transmit radiation through said aperture, and in an OFF position in which the capsule is out of registration with the aperture to prevent transmission of radiation through said aperture;
a linear cam having linear cam surfaces, the linear cam guide of the source carrier cooperatively engaged with said linear cam surfaces to permit sliding movement of the radiation source in source passageway, and
a rotary cam having spiral cam surfaces, the rotary cam guide of the source carrier cooperatively engaged with said spiral cam surfaces to cause movement of said one or more followers along said spiral cam surfaces upon rotation of the rotary cam;
wherein linear movement of said source carrier and capsule between said ON and OFF positions can be effected by rotation of the rotary cam.

2. The radiation source holder of claim 1, wherein the source carrier has a tubular body.

3. The radiation source holder of claim 2, wherein the source carrier includes a guide shaft extending from a surface thereof, the linear and rotary cam guides positioned for rotation on the guide shaft to cooperate with the linear and spiral cam surfaces of the linear and rotary cams.

4. The radiation source holder of claim 3, wherein the guide shaft extends through the source carrier and from a surface thereof on first and second sides of the source carrier.

5. The radiation source holder of claim 4, wherein the linear and rotary cam guides are positioned on the guide shaft on the first side of the source carrier, and a second linear cam guide and a second rotary cam guide are positioned on the guide shaft on a second side of the source carrier, the second linear and second rotary cam guides positioned fro rotation on the guide shaft to cooperate with the linear and spiral cam surfaces of the linear and rotary cams.
